(19) United States
(12) Patent Application Publication
(10) Pub. No.: US 2013/0160746 A1
(43) Pub. Date: Jun. 27, 2013

(54) Method And System For Regulated Exhaust Heating Of A Charcoal Canister Of An Emissions System To Reduce Heel

(71) Applicant: CONTINENTAL AUTOMOTIVE SYSTEMS, INC., Auburn Hills, MI (US)

(72) Inventors: Brian Gordon Woods, Chatham (CA); David William Balsdon, Chatham (CA); Adrian Ovidiu Crisan, Chatham (CA)

(73) Assignee: CONTINENTAL AUTOMOTIVE SYSTEMS, INC., Auburn Hills, MI (US)

(21) Appl. No.: 13/688,536

(22) Filed: Nov. 29, 2012

Related U.S. Application Data
(60) Provisional application No. 61/578,510, filed on Dec. 21, 2011.

(51) Int. Cl. F02M 33/06

(52) U.S. Cl. CPC F02M 33/06
USPC 123/521

(57) ABSTRACT

A evaporative emission control system includes a fuel tank, canister communicating with the fuel tank, air intake structure directing air to an internal combustion engine, a purge valve connected between the canister and the air intake structure, a vent valve associated with a source of ambient air, mixing structure associated with vent valve to selectively receive the ambient air that passes through the vent valve, a feed line connected between an exhaust flow path associated with the engine and the mixing structure, an output air flow from the mixing structure being received by the canister, and an exhaust valve in the feed line for controlling pressurized exhaust air flow, from the exhaust flow path, to the mixing structure. The exhaust air flow is mixed with the ambient air in the mixing structure with the output air flow therefrom purging the canister of hydrocarbons to be consumed by the engine.

This application claims the benefit of U.S. Provisional Application No. 61/578,510, filed on Dec. 21, 2011.

### FIELD

This invention relates to vapor management systems of vehicles and, more particularly, to a system that allows cleaning of a charcoal canister with heated, pressurized exhaust air.

### BACKGROUND

FIG. 1 shows a conventional evaporative emission control system (EVAP), generally indicated at 10, of a motor vehicle including a fuel vapor collection canister (e.g., a carbon canister) 12 and a normally closed canister purge valve 14 connected between a fuel tank 16 and an intake manifold 18 of an internal combustion engine 20 in a known fashion. A normally open canister vent valve 22 is in fluid communication between a vapor collection canister 12 and ambient atmospheric conditions via a filter 24. Under certain conditions, the purge valve 14 is opened to direct hydrocarbon vapors to the intake manifold 18 to be consumed by the engine 20.

After the canister 12 is purged, there is a certain amount of hydrocarbons that cannot be removed by flowing air at ambient temperature to purge the canister 12 completely. These residual hydrocarbons are known as the “heel”, which reduce the storage capacity of the canister 12.

On turbocharged engines, the manifold is under pressure much of the operating time and therefore cannot pull these hydrocarbons from the canister 12. Some engines do not have enough time without turbocharger operation to allow sufficient canister cleaning when manifold vacuum is available. Many conventional engine technologies result in significant reduced manifold vacuum which cannot purge the heel.

Thus, there is a need in an evaporative emission control system to clean the canister by removing the heel.

### SUMMARY

An object of the invention is to fulfill the need referred to above. In accordance with the principles of an embodiment, this objective is achieved by an evaporative emission control system for a vehicle. The system includes a fuel tank, a vapor collection canister in communication with the fuel tank, air intake structure directing air to an internal combustion engine of the vehicle, a purge valve connected between the canister and the air intake structure, a vent valve associated with a source of ambient air, mixing structure associated with vent valve to selectively receive the ambient air that passes through the vent valve, a feed line connected between an exhaust flow path associated with the engine and the mixing structure, with an output air flow from the mixing structure being received by the canister, and an exhaust valve in the feed line for controlling pressurized exhaust air flow, from the exhaust flow path, to the mixing structure. Under certain operating conditions, the exhaust air flow is received by the mixing structure along with ambient air received through the vent valve, with the output air flow from the mixing structure purging the canister of hydrocarbons through the purge valve to be consumed by the engine.

In accordance with another aspect of an embodiment, a method purges hydrocarbons from an evaporative emission control system of a vehicle. The control system includes a fuel tank, a vapor collection canister in communication with the fuel tank, air intake structure directing air to an internal combustion engine of the vehicle, and a purge valve connected between the canister and the air intake structure. The method ensures that pressured exhaust air flow from an exhaust flow path associated with the engine can be received by the canister. The pressurized exhaust air flow is selectively supplied to the canister to purge hydrocarbons from the canister through the purge valve to be consumed by the engine.

Other objects, features and characteristics of the present invention, as well as the methods of operation and the functions of the related elements of the structure, the combination of parts and economics of manufacture will become more apparent upon consideration of the following detailed description and appended claims with reference to the accompanying drawings, all of which form a part of this specification.

### BRIEF DESCRIPTION OF THE DRAWINGS

The invention will be better understood from the following detailed description of the preferred embodiments thereof, taken in conjunction with the accompanying drawings, in which:

FIG. 1 is a schematic illustration showing a conventional evaporative emission control system.

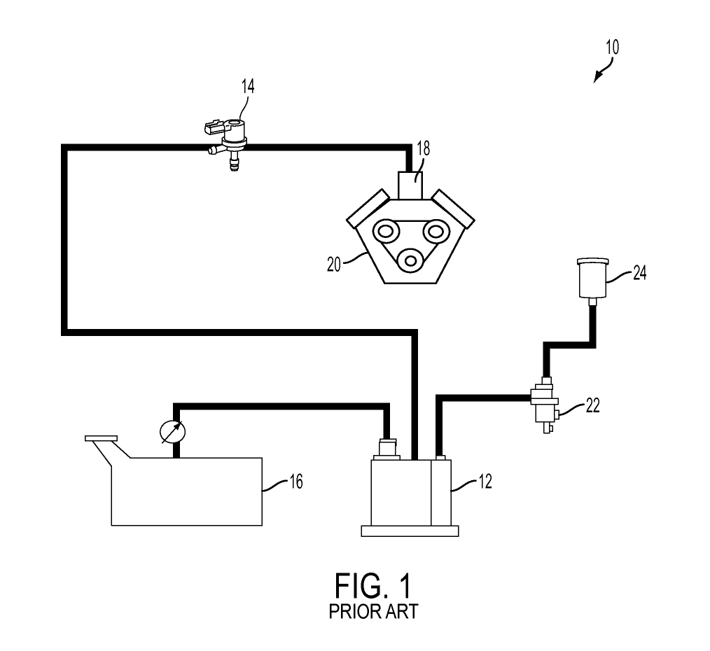

FIG. 2 is a schematic view of an evaporative emission control system that permits cleaning of the canister with pressure from exhaust air flow at a temperature above ambient temperature, according to an embodiment of the present invention.

### DETAILED DESCRIPTION OF AN EXEMPLARY EMBODIMENT

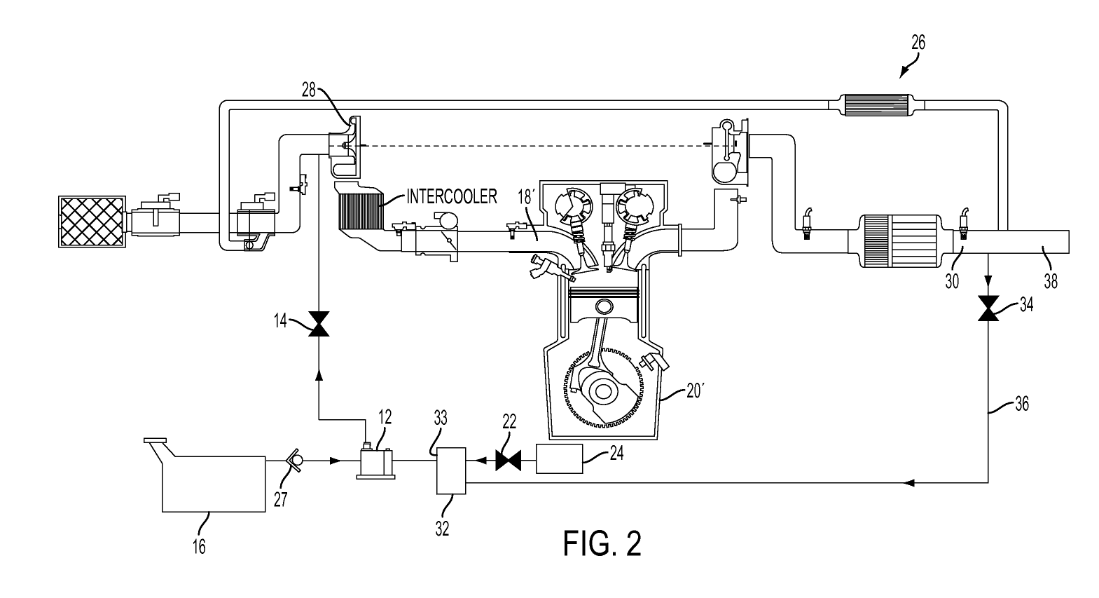

Referring to FIG. 2, an evaporative emission control system for a vehicle is shown, generally indicated at 26, in accordance with an embodiment. The system 26 comprises a fuel tank 16, a charcoal vapor collection canister 12 in communication with the tank 16, a tank isolation valve 27 between the canister 12 and tank 16 to prevent vapors from returning to the tank, air intake structure 28 directing air to an internal combustion engine 20′, a normally closed purge valve 14 between the canister 12 and the air intake structure 28, an exhaust flow path 30 receiving exhaust air flow 38 from the engine 20′, and a vent valve 22 and filter 24 for controlling flow of ambient air to a particulate separator and flow mixing structure 32. A purging output air flow 33 of the mixing structure 32 is received by the canister 12. An exhaust valve 34 is provided in a feed line 36 between the exhaust flow path 30 and the mixing structure 32. The valve 34 is constructed and arranged to reduce pressure of the exhaust air flow 38 and controls the exhaust air flow 38 into the mixing structure 32 and thus the canister 12. The mixing structure 32 controls temperature of purge air flow 33 into the canister 12 by selectively mixing the exhaust air flow 38 with the ambient air that is received from vent valve 22.

In the embodiment, the air intake structure 28 is a conventional turbocharger, but if no turbocharger is provided, it can be the engine intake manifold 18′ as a vacuum source.

Thus, under certain operating conditions (e.g., when the canister 12 is deemed to need purging) and when valve 34 is opened by a controller (not shown), the system 26 allows cleaning of the canister 12 in compliance with EVAP emission regulations. Pressurized exhaust air flow 38, which is at a temperature above ambient conditions, may be mixed in mixing structure 32 with ambient air that passes through vent valve 22 and the output air flow 33 enters the canister 12. Hydrocarbons in the canister 12 are purged through the purge valve 14 and are consumed in the engine 20′. This use of exhaust air flow 38 advantageously provides a higher temperature for the purging air flow 33 so as to recover more of the hydrocarbons in the canister 12 and reduce the heel. This increases the storage capacity for a given amount of charcoal in the canister 12. Increasing the storage capacity of the canister 12 allows smaller canisters to be used, or provides more robustness for usage of ethanol fuels which have been shown to increase the heel in a canister 12.

Although the mixing structure 32 is provided, it can be appreciated that instead of providing the mixing structure 32, the ambient air from valve 22 and the exhaust air flow 38 from valve 34 can be mixed in the canister 12. Temperature sensors (not shown) can be provided at least downstream of the output air flow 33 to ensure that the output air flow 33 is at a desired temperature.

On turbocharged engines, the manifold vacuum used in conventional EVAP systems is not available during turbocharger operation, but the use of the pressure of the exhaust air flow 38 allows the canister 12 to be purged even with the turbocharger 28 operating.

On conventional (non-turbocharged) systems, the most manifold vacuum is available at low engine speeds when total fuel required is low and the EVAP fuel can be a significant portion. The uncertainty of fuel content in the EVAP flow creates extra calibration effort to avoid engine stumble and stall. The pressurized system 26 can purge the canister 12 at high engine speeds (when no vacuum source is available) which allows easier calibration and lower vehicle development costs.

The foregoing preferred embodiments have been shown and described for the purposes of illustrating the structural and functional principles of the present invention, as well as illustrating the methods of employing the preferred embodiments and are subject to change without departing from such principles. Therefore, this invention includes all modifications encompassed within the spirit of the following claims.

What is claimed is:

1. An evaporative emission control system for a vehicle comprising:
a fuel tank,
a vapor collection canister in communication with the fuel tank,
air intake structure directing air to an internal combustion engine of the vehicle,
a purge valve connected between the canister and the air intake structure,
a vent valve associated with a source of ambient air,
mixing structure associated with vent valve to selectively receive the ambient air that passes through the vent valve,
a feed line connected between an exhaust flow path associated with the engine and the mixing structure, an output air flow from the mixing structure being received by the canister, and
an exhaust valve in the feed line for controlling pressurized exhaust air flow, from the exhaust flow path, to the mixing structure,
wherein, under certain operating conditions, the exhaust air flow is received by the mixing structure along with the ambient air received through the vent valve, with the output air flow from the mixing structure purging the canister of hydrocarbons through the purge valve to be consumed by the engine.

2. The system of claim 1, further comprising a tank isolation valve between the tank and the canister constructed and arranged to prevent vapors from returning to the tank.

3. The system of claim 1, wherein the air intake structure is a turbocharger.

4. The system of claim 1, wherein the air intake structure is an intake manifold associated with the engine.

5. The system of claim 1, further comprising a filter for filtering ambient air prior to being received by the vent valve.

6. The system of claim 1, wherein the vapor collection canister is a charcoal vapor collection canister.

7. A method of purging hydrocarbons from an evaporative emission control system of a vehicle, the control system including a fuel tank, a vapor collection canister in communication with the fuel tank, air intake structure directing air to an internal combustion engine of the vehicle, and a purge valve connected between the canister and the air intake structure, the method comprising the steps of:
ensuring that pressured exhaust air flow from an exhaust flow path associated with the engine can be received by the canister, and
selectively supplying the pressurized exhaust air flow to the canister to purge hydrocarbons from the canister through the purge valve to be consumed by the engine.

8. The method of claim 7, further comprising mixing the pressurized exhaust air flow that is at a temperature above ambient temperature, with ambient air prior to the supplying step so that a mixture of the exhaust air flow and the ambient air is supplied to the canister.

9. The method of claim 7, wherein a mixing structure is provided upstream of the canister and the mixing step occurs in the mixing structure.

10. The method of claim 7, wherein the air intake structure is a turbocharger and the supplying step can occur during operation of the turbocharger.

11. The method of claim 7, wherein the air intake structure is an intake manifold associated with the engine, and the supplying step can occur even when no vacuum can be obtained by the intake manifold.

12. The method of claim 8, wherein the air intake structure is a turbocharger and the supplying step can occur during operation of the turbocharger.

13. The method of claim 8, wherein the air intake structure is an intake manifold associated with the engine, and the supplying step can occur even when no vacuum can be obtained by the intake manifold.
